(19) United States
(12) Patent Application Publication
(10) Pub. No.: US 2026/0337506 A1
(43) Pub. Date: Oct. 29, 2026

(54) METHOD FOR PREPARING BIODIESEL

(71) Applicant: National Tsing Hua University, Hsinchu City (TW)

(72) Inventors: Chen-Yi Hsu, Hsinchu City (TW); Yu-Hsien Liu, Hsinchu City (TW); Hsien-Wen Chao, Hsinchu City (TW); Tsun-Hsu Chang, Hsinchu City (TW); Hung-Chun Hsu, Hsinchu City (TW)

(73) Assignee: National Tsing Hua University, Hsinchu City (TW)

(21) Appl. No.: 19/271,672

(22) Filed: Jul. 16, 2025

(30) Foreign Application Priority Data
Apr. 29, 2025 (TW) 114116108

(51) Int. Cl. C10L 1/02; C11C 3/00

(52) U.S. Cl. CPC C10L 1/026; C11C 3/003; C10L 2200/0476; C10L 2290/06; C10L 2290/141

(57) ABSTRACT

A method for preparing biodiesel includes heating an oil material to a reaction temperature, where the oil material includes an oil matrix and an acid reactant; adding an alcohol reactant and an iron catalyst into the oil material while maintaining the reaction temperature to promote an esterification reaction between the alcohol reactant and the acid reactant; conducting a transesterification reaction of the oil matrix to generate the biodiesel.

### CROSS-REFERENCE TO RELATED APPLICATION

This application claims the priority benefit of Taiwan application serial no. 114116108, filed on Apr. 29, 2025. The entirety of the above-mentioned patent application is hereby incorporated by reference herein and made a part of this specification.

### BACKGROUND

### Technical Field

The disclosure relates to a method for preparing renewable energy; more particularly, the disclosure relates to a method for preparing biodiesel.

### Description of Related Art

The demand for biodiesel has been increasing year by year. However, the practice of converting arable land, originally intended for food production, to cultivate biodiesel feedstock has sparked considerable controversy. Consequently, recycling waste cooking oil as a raw material for biodiesel production has emerged as a significant trend. Nevertheless, the overly high acid value (AV) of the waste cooking oil renders it unfeasible for an immediate transesterification reaction to produce the biodiesel, and it is imperative to first reduce the AV to be 3.0 or below through an esterification reaction.

Currently, the esterification reaction process employed to reduce the AV of the waste cooking oil requires excessive time (e.g., more than 6 hours). Therefore, developing methods that can rapidly reduce the AV of the waste cooking oil to expedite the preparation of the biodiesel has become one of the objectives for improvement sought by the relevant industry.

### SUMMARY

According to an embodiment of the disclosure, a method for preparing biodiesel includes heating an oil material to a reaction temperature, wherein the oil material includes an oil matrix and an acid reactant; adding an alcohol reactant and an iron catalyst into the oil material while maintaining the reaction temperature to promote an esterification reaction between the alcohol reactant and the acid reactant; conducting a transesterification reaction of the oil matrix to generate the biodiesel.

In an embodiment of the disclosure, the reaction temperature ranges from 180 °C to 220 °C.

In an embodiment of the disclosure, the oil matrix includes soybean oil, palm oil, green seed canola oil, or a combination thereof.

In an embodiment of the disclosure, the acid reactant includes oleic acid.

In an embodiment of the disclosure, the alcohol reactant includes glycerol.

In an embodiment of the disclosure, a particle size of the iron catalyst ranges from 50 μm to 200 μm.

In an embodiment of the disclosure, the iron catalyst includes iron powder.

In an embodiment of the disclosure, the step of maintaining the reaction temperature is performed through microwave heating.

In an embodiment of the disclosure, a reaction time of the esterification is less than 120 minutes.

In an embodiment of the disclosure, a reaction pressure of the esterification reaction ranges from 100 torr to 200 torr.

In an embodiment of the disclosure, based on a total weight of the oil material, the alcohol reactant, and the iron catalyst, an iron catalyst content ranges from 0.5 wt % to 4.0 wt %.

In an embodiment of the disclosure, a molar ratio of the alcohol reactant to the acid reactant ranges from 1 to 20.

In an embodiment of the disclosure, a molar ratio of the oil matrix to the acid reactant ranges from 1.1 to 2.0.

Based on the above, the method for preparing the biodiesel according to one or more embodiments of the disclosure can reduce the AV of the oil material to 3.0 or below within 120 minutes, thereby shortening the preparation time of the biodiesel.

To make the above features and advantages of the disclosure more apparent and understandable, embodiments are described in detail below with reference to the accompanying drawings.

### BRIEF DESCRIPTION OF THE DRAWINGS

FIG. 1 is a schematic diagram of an esterification reaction apparatus according to an embodiment of the disclosure.

FIG. 2A shows analysis results of design of experiments (DOE).

FIG. 2B shows experimental results of the esterification reaction conducted at 200 °C with no catalyst or with iron powder, Fe₂O₃ powder, and Fe₃O₄ powder catalysts, each with a catalyst loading of 0.3 weight % (wt %), under conventional conduction heating and microwave heating, respectively.

FIG. 3A shows an electric field distribution in the absence of the iron powder.

FIG. 3B shows an electric field distribution in the presence of the iron powder.

FIG. 4A shows a gas chromatography (GC) analysis result of a product obtained after conducting the esterification reaction through microwave heating under catalyst-free conditions.

FIG. 4B shows a GC analysis result of a product obtained after conducting the esterification reaction through microwave heating with use of an iron powder catalyst.

FIG. 5A is a photograph of an obtained product detected using potassium ferricyanide (K₃[Fe(CN)₆]).

FIG. 5B is a photograph of an obtained product detected using potassium thiocyanate (KSCN).

FIG. 6A shows a scanning electron microscope (SEM) photograph of unused iron powder.

FIG. 6B shows an SEM photograph of recycled iron powder.

FIG. 7 is a curve diagram illustrating a normalized acid value (AV) changes together with a reaction time.

FIG. 8 is a curve diagram illustrating a pH value changes together with the reaction time.

FIG. 9 is a curve diagram illustrating a normalized reaction rate k/k0 changes together with an iron powder concentration under microwave heating.

### DESCRIPTION OF THE EMBODIMENTS

Hereinafter, embodiments of the disclosure will be described in detail. However, these embodiments simply serve for exemplifying instead of limiting the scope of the disclosure.

The terminology “about,” “approximately,” or “substantially” used herein includes the average of the stated value and an acceptable range of deviations from the particular value as determined by those skilled in the art. For instance, the terminology “about” may refer to as being within one or more standard deviations of the stated value, or within ±30%, ±20%, ±10%, or ±5%. Furthermore, the terminology “about,” “approximately,” or “substantially” as used herein may be chosen from a range of acceptable deviations or standard deviations depending on the optical properties, chemical properties, or other properties, rather than one standard deviation for all properties.

The terminologies and language used herein merely serve to describe exemplary embodiments and do not limit the disclosure. In such cases, the singular includes the plural unless the context explains otherwise.

In this disclosure, a range represented by “a numerical value to another numerical value” is a concise way of representing the range to avoid listing each and every numerical value within the range in the specification. Therefore, the recitation of a specific numerical range covers any numerical value within the stated numerical range and smaller numerical ranges defined by any numerical value within the stated numerical range, as if such arbitrary numerical values and smaller numerical ranges were explicitly recited herein.

In one or more embodiments of the disclosure, a method for preparing biodiesel can include following steps, which should however not be construed as a limitation in the disclosure. First, an oil material is heated to a reaction temperature, and the oil material includes an oil matrix and an acid reactant. Next, while the reaction temperature is maintained, an alcohol reactant and an iron catalyst are added into the oil material to promote an esterification reaction between the alcohol reactant and the acid reactant. After that, a transesterification reaction of the oil matrix is conducted to generate the biodiesel. The above steps are described in detail below.

In the method for preparing the biodiesel provided in one or more embodiments of the disclosure, the oil material can be waste oil, such as waste cooking oil or used cooking oil, which should however not be construed as a limitation in the disclosure. For instance, the oil material includes an oil matrix and an acid reactant, and the acid reactant can be used to simulate free acid groups in waste oil, such that the oil material has an acid value (AV) similar to that of the waste oil. The AV is a measurement standard for the quantity of the free acid groups (e.g., free fatty acid groups) in a chemical substance and can be defined as the number of milligrams of sodium hydroxide (NaOH) or potassium hydroxide (KOH) required when titrating 1 gram of the sample to be tested (e.g., the oil material). In some embodiments, the oil material is waste oil with an AV greater than 3.0. In some embodiments, the oil matrix includes vegetable oil, such as soybean oil, palm oil, green seed canola oil, or a combination thereof, which should however not be construed as a limitation in the disclosure. In some embodiments, the acid reactant includes oleic acid, which should however not be construed as a limitation in the disclosure. In some embodiments, the alcohol reactant includes glycerol (C₃H₅(OH)₃), which should however not be construed as a limitation in the disclosure. The iron catalyst can include iron powder, Fe₂O₃ powder, Fe₃O₄ powder, or a combination thereof. After the esterification reaction between the acid reactant and the alcohol reactant is conducted, the AV of the oil material can be reduced to 3.0 or below.

A reaction temperature of the esterification reaction can be set to about 180 °C to 220 °C, e.g. about 200 °C. In some embodiments, a reaction pressure of the esterification reaction is a vacuum of about 100 torr to 200 torr, e.g. about 160 torr. The purpose of maintaining the vacuum is to remove water vapor generated during the reaction process because the water vapor can cause a reverse reaction, thereby reducing the reaction rate. A conventional esterification process performed through conduction heating (e.g., using a heating mantle to heat the reactor) and using concentrated sulfuric acid as a catalyst requires about 6 hours to reduce the AV of the oil material to 3.0 or below, and the AV of the oil material can be reduced to 3.0 or below within 120 minutes according to one or more embodiments of the disclosure, thereby shortening the preparation time of the biodiesel.

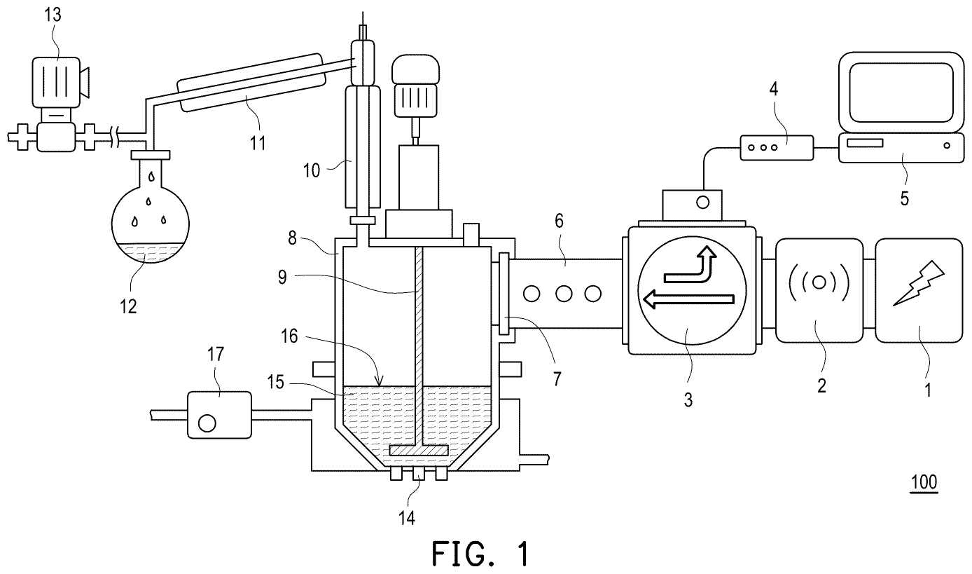

FIG. 1 is a schematic diagram of an esterification reaction apparatus 100 according to an embodiment of the disclosure. At the room temperature (e.g., 25 °C), the oil material including, for instance, the oleic acid and the soybean oil is added into the reactor 8 and thoroughly mixed with a metal stirring rod 9 to generate a uniform oil material mixture. A molar ratio of the soybean oil to the oleic acid can range from about 1 to 1.5, e.g., 1.18. The metal stirring rod 9 can be disposed at a center position of the reactor 8. The mixture can be gradually heated by using a microwave power system until the temperature reaches 200 °C Then, glycerol and iron powder are sequentially added into the reactor 8 to generate a reaction mixture 15. A molar ratio of the glycerol to the oleic acid can range from about 1 to 20, e.g., from about 1.1 to 2.0. The metal stirring rod 9 can rotate at a speed of about 300 rpm, for instance, so as to ensure that the reaction mixture 15 is evenly mixed.

A particle size of the iron powder can range from about 50 μm to 200 μm, e.g., 100 μm. The iron powder can be purchased from Emperor Chemical Co., LTD (Japan). The oleic acid can be purchased from Sigma-Aldrich (USA). The glycerol can be purchased from UniRegion Bio-Tech (Taiwan). The soybean oil can be purchased from FMC Taiwan Co., Ltd.

In some embodiments, the microwave power system includes a microwave power supply 1, a magnetron 2, and a circulator 3, wherein the magnetron 2 converts electrical energy from the microwave power supply 1 into microwaves, and the circulator 3 can prevent reflective power from damaging the microwave power supply 1 and the magnetron 2. A direction in which the microwaves are incident to the reactor 8 is perpendicular to the metal stirring rod 9 and parallel to a surface 16 of the reaction mixture 15 within the reactor 8, so as to ensure effective heating of the reaction mixture 15, e.g., leading the reaction mixture 15 to reach an equilibrium temperature of 200 °C regulated by the temperature controller 17. In some embodiments, the microwave power of the microwave power supply 1 ranges from about 1,000 W to 1,500 W, e.g., 1,300 W.

The design of the reactor 8 can depend on its inner wall radius and the height of the surface 16. In some embodiments, given a fixed inner wall radius, the capacity of the reaction mixture 15 is determined according to resonance absorption modes of the reactor 8.

A three-stub tuner 6 can be employed to adjust the microwave power and minimize the reflective power of the reactor 8. In some embodiments, a Teflon window 7 is utilized to isolate the reactor 8 from the three-stub tuner 6, so as to ensure that the reaction mixture 15 does not leak into the microwave power system. In some embodiments, a reflective signal is monitored via a USB connector 4 and a computer 5.

Evaporated reactants can be condensed in the oil condenser 10 maintained at about 70 °C and returned to the reactor 8. Water vapor can be cooled to about 20 °C in the water condenser 11 and collected by the water collector 12, thereby removing water as a product from the reaction mixture 15.

Throughout the reaction process, a vacuum pump 13 can be used to maintain the reaction pressure between about 100 torr to 200 torr, e.g., at about 160 torr. Throughout the reaction process, samples can be collected at intervals of 10 minutes from a discharge port 14 for analysis. These samples can be filtered through filter paper to separate out the iron powder and ensure the accuracy in subsequent tests. Subsequently, titration equipment can be used for NaOH titration to conduct titration tests on the filtered samples to analyze their respective AV, i.e., detecting the free fatty acid content in the samples, thereby evaluating the reaction progress. The test results are recorded and utilized to analyze the reaction rate and product quality. In some embodiments, the AV measured before the start of the reaction serves as the normalization standard.

A design of experiments (DOE) method can be used to determine the optimal experimental combination. For instance, selected factors can include the reaction temperature of the esterification reaction, the iron powder content (wt %), and the molar ratio of the glycerol to the oleic acid, wherein the iron powder content is a ratio of a weight of the iron powder to a total weight of the oleic acid, the soybean oil, the glycerol, and the iron powder. Each factor can be assigned three levels, wherein the three reaction temperature levels of the esterification reaction are 180 °C, 200 °C, and 220 °C; the three levels for the iron powder content are 0 wt %, 0.3 wt %, and 0.6 wt %; and the three levels for the molar ratio of the glycerol to the oleic acid are 1.15, 1.25, and 1.35. Besides, a 3×3 orthogonal array is used to design the experiments.

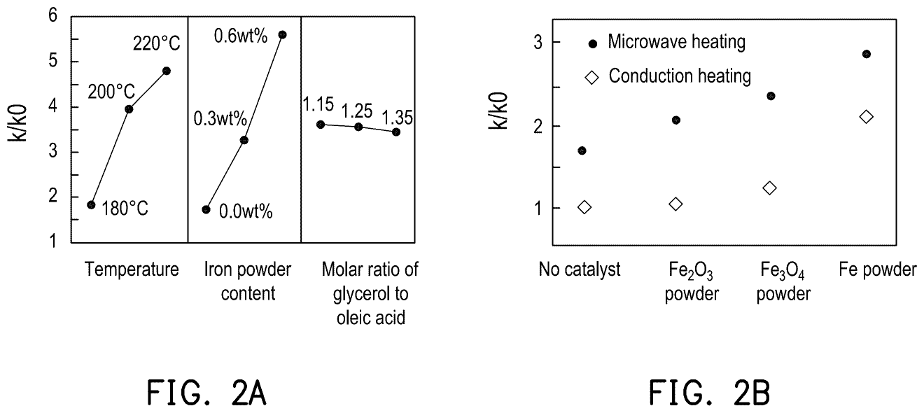

FIG. 2A shows analysis results of DOE. From FIG. 2A, it can be observed that the increase in the normalized reaction rate k/k0 obtained by increasing the reaction temperature of the esterification reaction from 200 °C to 220 °C is not as much as the increase from 180 °C to 200 °C. Moreover, higher reaction temperatures not only increase energy consumption but also cause thermal decomposition of the glycerol, leading to the formation of more by-products. Therefore, based on a balance between reaction efficiency and energy consumption, the optimal reaction temperature can be about 200 °C.

When the AV of the oil material is greater than 3.0, converting the free fatty acids into fatty acid esters by conducting the esterification reaction can reduce the risk of saponification. Subsequently, triglycerides contained in the soybean oil can react with methanol or ethanol to conduct a transesterification reaction, catalyzed by a catalyst (e.g., an acidic catalyst such as sulfuric acid or a basic catalyst such as NaOH), to generate the fatty acid esters (i.e., the biodiesel) and the by-product glycerol. As the main component of vegetable oil is triglycerides, the transesterification reaction releases the corresponding glycerol. In order to avoid the formation of excessive waste glycerol, the number of moles of glycerol can be set slightly higher than the number of moles of the oleic acid; namely, the molar ratio of the glycerol to the oleic acid is set slightly greater than 1 for economic benefits. From FIG. 2A, it can be observed that increasing the molar ratio of the glycerol to the oleic acid from 1.15 to 1.35 does not significantly affect the normalized reaction rate k/k0. Therefore, in order to achieve the optimal economic benefits without affecting the reaction efficiency, the optimal molar ratio of the glycerol to the oleic acid can be about 1.15.

From the DOE analysis, it can be observed that the iron powder content is one of the key factors affecting the normalized reaction rate k/k0. The iron powder is a widely available and cost-effective material and provides significant advantages for large-scale production. Utilizing this advantage, using the iron powder to catalyze the esterification reaction can be an important breakthrough for future bioenergy applications.

FIG. 2B shows experimental results of the esterification reaction conducted at 200 °C with no catalyst or with iron powder, Fe₂O₃ powder, and Fe₃O₄ powder catalysts, each with a catalyst loading of 0.3 weight % (wt %), under conventional conduction heating and microwave heating, respectively. Normalization is performed by using no catalyst and conventional conduction heating as a reference standard. From FIG. 2B, it can be observed that under the conventional conduction heating, the catalytic activity of the Fe₂O₃ powder and the Fe₃O₄ powder is extremely low, while the iron powder demonstrates a significant catalytic effect. Notably, under the microwave heating, the iron powder shows the best catalytic performance, and the Fe₂O₃ powder and the Fe₃O₄ powder also show increased catalytic effect, wherein the normalized reaction rate k/k0 of the Fe₃O₄ powder is higher than the normalized reaction rate k/k0 of the Fe₂O₃ powder, which is significantly different from the result observed with the conventional conduction heating; this is due to the microwave electromagnetic field directly interacting with the reactants' molecular structure, i.e., the non-thermal effects of microwaves.

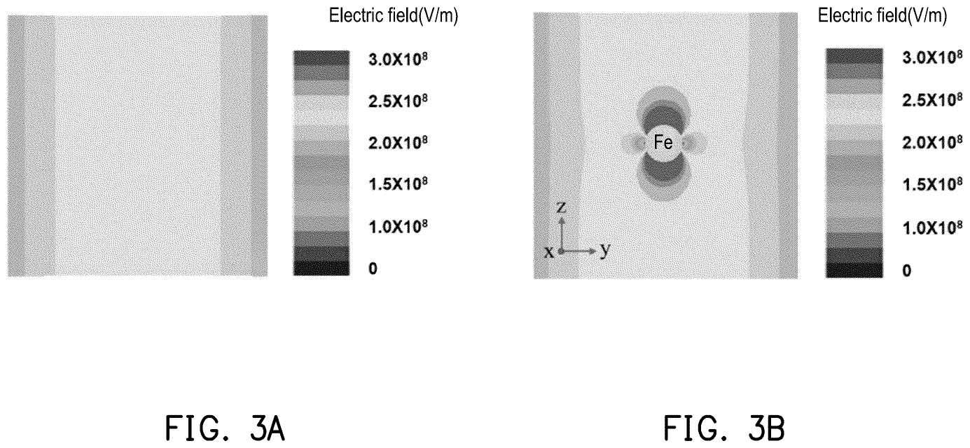

FIG. 3A shows an electric field distribution in the absence of the iron powder. FIG. 3B shows an electric field distribution in the presence of the iron powder. From FIG. 3B, it can be observed that under the action of the microwave electromagnetic field, a locally enhanced electric field is formed around the iron powder. Notably, the iron powder has the ability to concentrate the microwave field, exhibiting a strong local electric field enhancement effect, which not only provides the thermal effects of radiative heating but also provides the non-thermal effects of direct interaction between microwaves and molecules or atoms, thereby changing the molecular motion and energy distribution in the reaction process. Since the iron powder can effectively concentrate and amplify the electric field, by promoting the direct interaction between the electric field and the reactants, the non-thermal effects of microwaves are further enhanced, causing the reaction rate to accelerate significantly. In addition, the interaction between the microwaves and the magnetic properties of the iron powder also affects its surface catalytic activity. The microwave field induces oscillations in surface electrons, which can create generate more active catalytic sites, thereby enhancing the catalytic efficiency of the iron powder and further accelerating the esterification reaction.

In addition, in the esterification reaction process of the oleic acid, microwave heating provides an acidic environment for the electrochemical reactions of iron oxides, leading to their reduction. Typically, the reduction process of iron oxides follows the order below: Fe₂O₃ is first reduced to Fe₃O₄, and Fe₃O₄ is then reduced to iron. Therefore, from a chemical reaction kinetics perspective, the efficiency of directly reducing Fe₃O₄ to iron is greater than that of indirectly reducing Fe₂O₃ to iron. From the aforementioned results, it can be known that the catalytic effect of the iron powder is superior to Fe₂O₃ and Fe₃O₄, and moreover, microwave heating can also prevent the oxidation of iron.

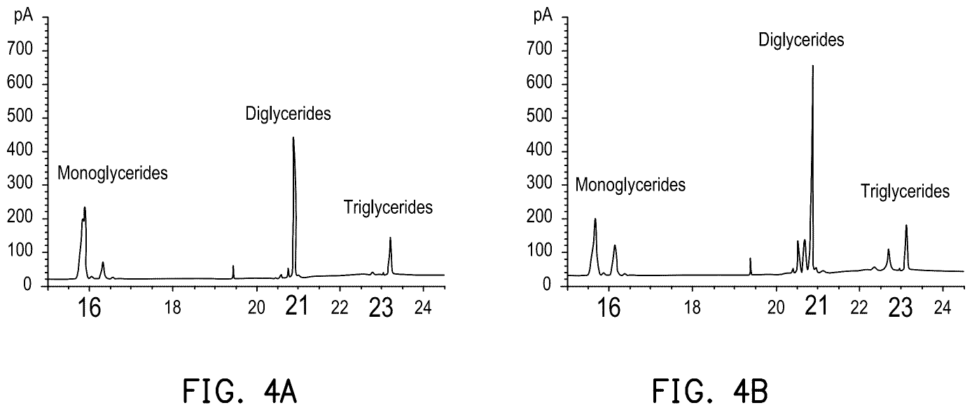

Using the iron powder as the catalyst may require further consideration of two primary issues: whether unexpected reaction by-products are generated, and whether the iron powder undergoes oxidation. Gas chromatography (GC) can be utilized to analyze the composition of the generated product. FIG. 4A shows a GC analysis result of a product obtained after conducting the esterification reaction through microwave heating under catalyst-free conditions. FIG. 4B shows a GC analysis result of a product obtained after conducting the esterification reaction through microwave heating with use of an iron powder catalyst. In FIG. 4A and FIG. 4B, the peaks at 16, 21, and 23 correspond to monoglycerides, diglycerides, and triglycerides, respectively. From FIG. 4B, it can be observed that the composition of the product obtained using the iron powder as the catalyst is mostly located at these 3 peaks, confirming that using the iron powder as the catalyst does not lead to the formation of a non-negligible amount of unexpected reaction by-products.

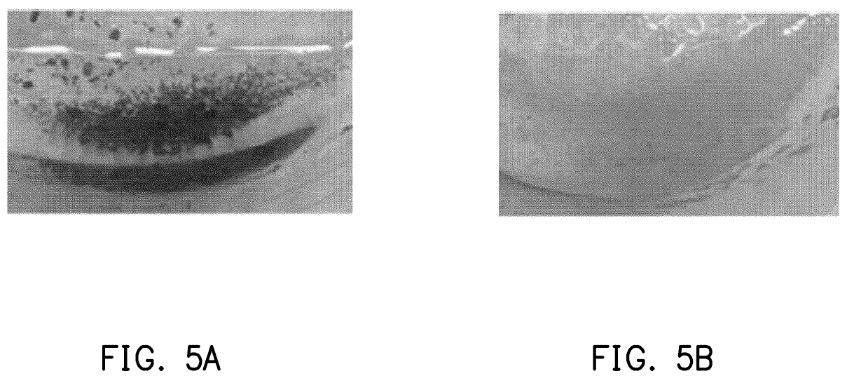

In investigating whether the iron powder catalyst undergoes oxidation, potassium ferricyanide (K₃[Fe(CN)₆]) can be used to detect the presence of Fe²⁺ in the obtained product, as K₃[Fe(CN)₆ shows a blue color after reacting with Fe²⁺. Additionally, potassium thiocyanate (KSCN) can be used to detect whether Fe³⁺ is present in the obtained product, as KSCN generates blood-red iron thiocyanate ions after reacting with Fe³⁺. FIG. 5A is a photograph of an obtained product detected using K₃[Fe(CN)₆]. FIG. 5B is a photograph of an obtained product detected using KSCN. From FIG. 5A and FIG. 5B, it can be observed that when detecting the obtained product using K₃[Fe(CN)₆, its color does not turn blue, and when detecting the obtained product using KSCN, its color does not turn blood-red, indicating that the iron powder does not undergo oxidation. As such, the iron powder can be recycled by a method such as filtration, for instance, and reused, thereby reducing the cost of using the iron powder.

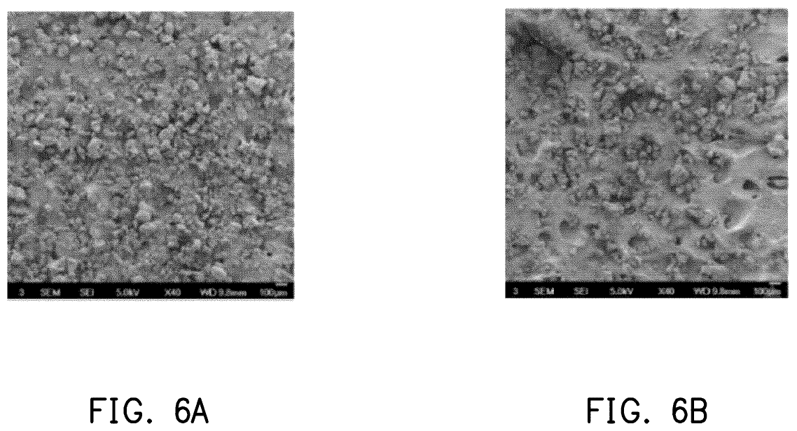

FIG. 6A shows a scanning electron microscope (SEM) photograph of unused iron powder. FIG. 6B shows an SEM photograph of recycled iron powder. From FIG. 6A and FIG. 6B, it can be observed that the appearance of the unused iron powder and the recycled iron powder is almost the same, further confirming that the iron powder can maintain its physical properties when acting as a catalyst during the microwave heating. In some embodiments, the recycled rate of the iron powder is about 97.96% after filtration.

Generally, in chemical catalytic reactions, as the amount of catalyst increases, the reaction rate also increases, but once the amount reaches a certain level, even increasing the catalyst amount cannot significantly increase the reaction rate. Further investigating the saturation point of the iron powder catalyst allows a reasonable assessment of the catalyst amount required for large-scale production, contributing to the optimization of the production process, improving production efficiency, and reducing costs.

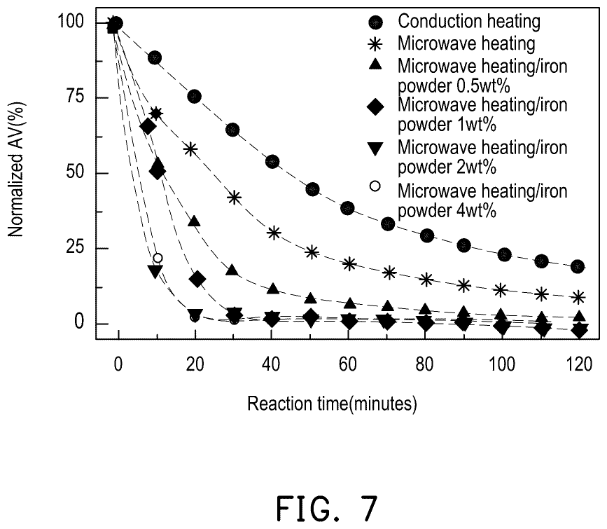

FIG. 7 is a curve diagram illustrating a normalized AV changes together with a reaction time (minutes). In the esterification reaction catalyzed under microwave heating, as the iron powder concentration increases from 0.5 wt % to 2 wt %, the normalized AV rapidly decreases with the passage of time. When the iron powder concentration is in a range from 2 wt % to 4 wt %, the reaction curves show consistency, and the normalized AV successfully decreases to about 3.0 or below after 20 minutes. In some embodiments, when the iron powder concentration is 2 wt %, a conversion rate of about 97% can be reached after the reaction proceeds for 20 minutes, and a conversion rate of about 98% can be reached after the reaction proceeds for 60 minutes. The term “conversion rate” used in this disclosure refers to the proportion of free fatty acids converted to fatty acid esters during the reaction process, and the conversion rate is calculated by the difference between the AV at the start of the reaction and the AV at the end of the reaction. The calculation formula is as follows:

Conversion rate (%)=[(AV0−AVt)/AV0]×100

Here, AV0 is the AV at the start of the reaction, and AVt is the AV when the reaction proceeds for t minutes. This conversion rate can reflect the degree of conversion of the free fatty acids in the esterification reaction and serves as an important indicator for evaluating catalytic efficiency and reaction process.

Table 1 shows the results of the normalized reaction rate (k/k0) for the esterification reaction conducted under conventional conduction heating and microwave heating without using any catalyst (0 wt %) and using 0.5 wt % to 4 wt % of the iron powder catalyst, respectively, wherein the results are normalized based on the reaction rate under conventional conduction heating without using a catalyst. From Table 1, it can be observed that using only microwave heating without using any catalyst can increase the reaction rate by about 1.62 times. Additionally, when using 4 wt % of the iron powder catalyst, the reaction rate can be increased by about 9 times under conventional conduction heating, whereas the reaction rate can be increased by about 14 times under microwave heating.

TABLE 1

| | k/k0 | |
|---|---|---|
| | (Conventional | k/k0 |
| Iron powder | conduction | (Microwave |
| content | heating) | heating) |

| | | | |
|---|---|---|---|
| 0 | wt % | 1.00 +/− 0.102 | 1.62 +/− 0.080 |
| 0.5 | wt % | 4.03 +/− 0.352 | 5.71 +/− 0.548 |
| 1 | wt % | 5.61 +/− 0.539 | 9.69 +/− 0.646 |
| 2 | wt % | 8.04 +/− 0.610 | 12.9 +/− 0.680 |
| 4 | wt % | 8.43 +/− 0.752 | 13.58 +/− 0.810 |

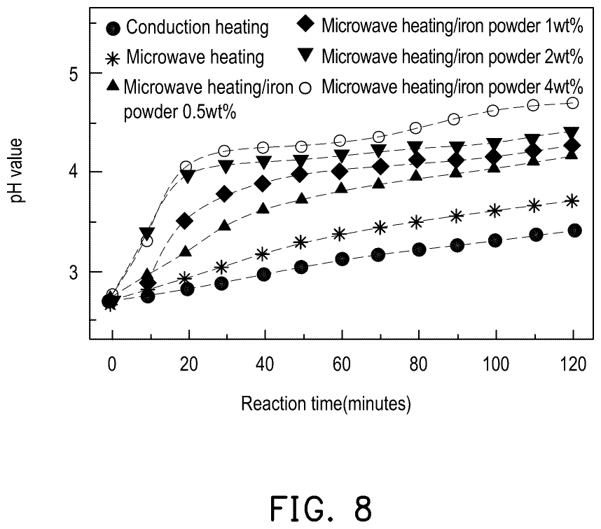

FIG. 8 is a curve diagram illustrating a pH value of a reaction mixture changes together with the reaction time (minutes). As shown in FIG. 8, the pH value increases from approximately 2.5 to approximately 4.5 or above over the course of the reaction. The rise in the pH value is associated with the consumption of acidic substances during the reaction process. As the reaction proceeds, the acidic substances are gradually converted into esters, leading to an increase in the pH value. This change in pH value can also affect the activity of the catalyst. For acid catalysts, a lower pH value helps enhance the catalytic efficiency, whereas an increase in the pH value can reduce the effectiveness of the catalyst.

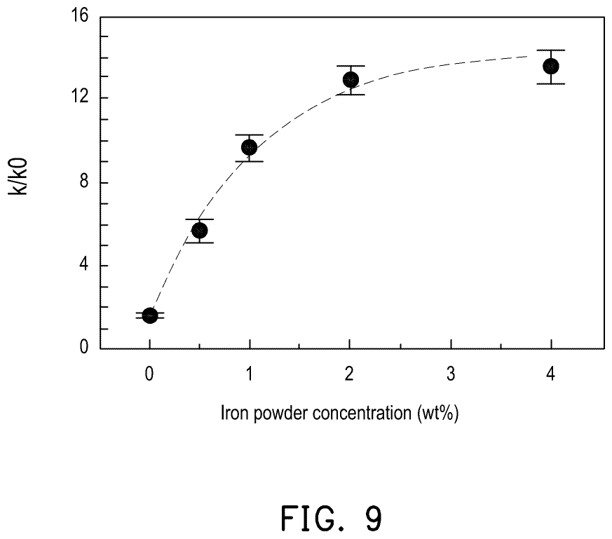

In further analysis, the reaction rate k is calculated using the following equation (1), and the normalized reaction rate k/k0 can be obtained. FIG. 9 is a curve diagram illustrating a normalized reaction rate k/k0 changes together with an iron powder concentration under microwave heating. From FIG. 9, it can be observed that when the iron powder concentration is lower than about 2 wt %, increasing the iron powder concentration can significantly increase the normalized reaction rate. However, when the iron powder concentration is higher than 2 wt %, further increasing the iron powder concentration cannot significantly increase the normalized reaction rate.

$$r = - \frac{d [ A ]}{dt} = {k [ A ]}_{t} ⇒ {[ A ]}_{t} = {[ A ]}_{0} exp ( - kt ) \qquad equation ( 1 )$$

During the esterification reaction, the core role of the iron powder as a catalyst is to reduce the activation energy, accelerate the reaction rate, and promote the rearrangement of bonds between reactants. Iron ions (such as Fe³⁺ or Fe²⁺) function as Lewis acids, which can accept electron pairs from carboxylic acid (R—COOH) or alcohol (R—OH). When the iron catalyst interacts with these oxygen-containing functional groups, it redistributes the electron density in these groups, thereby activating the reactants. This activation reduces the activation energy of the esterification reaction, allowing it to proceed at lower temperatures or faster rates.

For instance, the iron catalyst can effectively activate carboxylic acid molecules. When the oxygen in the carbonyl group (C═O) of the carboxylic acid coordinates with the iron ion, the C═O bond in the carboxyl group becomes more polarized, making the carbon more electrophilic. This facilitates the hydroxyl group (OH) in the alcohol to perform nucleophilic attack, promoting the formation of the ester bond. Additionally, by coordinating with the carboxyl and hydroxyl groups of the reactants, the iron catalyst can also effectively stabilize reaction intermediates and encourage the removal of water. The water removal can drive the reaction toward ester formation and prevent the reverse reaction, and rapid water removal can prevent the generated water molecules from inhibiting the activity of the catalyst, thereby increasing the overall reaction rate.

Microwave heating causes polar molecules to frequently rotate and vibrate, and the enhancement of molecular motion further enhances the frequency of intermolecular collisions, thereby accelerating the chemical reaction. Additionally, this molecular motion also redistributes the electron clouds of the reactive molecules within the microwave field, further reducing the activation energy, promoting the chemical reaction, and thereby improving the reaction kinetics. When using metal catalysts, these metals strongly interact with the microwave field. Under microwave radiation, magnetic metals generate intense oscillation and heating effects, significantly enhancing the catalytic rate and improving the selectivity of the reaction.

To sum up, according to one or more embodiments of the disclosure, the iron powder catalyst, assisted by microwave heating, can significantly reduce the AV of the oil material from greater than 3.0 to 3.0 or below within 120 minutes, thereby significantly shortening the time required to prepare the biodiesel.

Although the disclosure has been disclosed in the embodiments as above, it is not intended to limit the disclosure. Any person having ordinary knowledge in the art can make minor modifications and refinements without departing from the spirit and scope of this disclosure. Therefore, the protection scope of this disclosure shall be defined by the appended claims.

What is claimed is:

1. A method for preparing biodiesel, comprising:
heating an oil material to a reaction temperature, wherein the oil material comprises an oil matrix and an acid reactant;
adding an alcohol reactant and an iron catalyst into the oil material while maintaining the reaction temperature to promote an esterification reaction between the alcohol reactant and the acid reactant; and
conducting a transesterification reaction of the oil matrix to generate the biodiesel.

2. The method according to claim 1, wherein the reaction temperature ranges from 180 °C to 220 °C.

3. The method according to claim 1, wherein the oil matrix comprises soybean oil, palm oil, green seed canola oil, or a combination thereof.

4. The method according to claim 1, wherein the acid reactant comprises oleic acid.

5. The method according to claim 1, wherein the alcohol reactant comprises glycerol.

6. The method according to claim 1, wherein a particle size of the iron catalyst ranges from 50 μm to 200 μm.

7. The method according to claim 1, wherein the iron catalyst comprises iron powder.

8. The method according to claim 7, wherein the step of maintaining the reaction temperature is performed through microwave heating.

9. The method according to claim 1, wherein a reaction time of the esterification is less than 120 minutes.

10. The method according to claim 1, wherein a reaction pressure of the esterification reaction ranges from 100 torr to 200 torr.

11. The method according to claim 1, wherein based on a total weight of the oil material, the alcohol reactant, and the iron catalyst, an iron catalyst content ranges from 0.5 wt % to 4.0 wt %.

12. The method according to claim 1, wherein a molar ratio of the alcohol reactant to the acid reactant ranges from 1 to 20.

13. The method according to claim 1, wherein a molar ratio of the oil matrix to the acid reactant ranges from 1.1 to 2.0.
